(19) United States
(12) Patent Application Publication
(10) Pub. No.: US 2022/0223066 A1
(43) Pub. Date: Jul. 14, 2022

(54) METHOD, DEVICE, AND COMPUTER PROGRAM PRODUCT FOR ENGLISH PRONUNCIATION ASSESSMENT

(71) Applicant: Ping An Technology (Shenzhen) Co., Ltd., Shenzhen (CN)

(72) Inventors: Ziyi CHEN, Palo Alto, CA (US); Iek heng CHU, Palo Alto, CA (US); Wei CHU, Palo Alto, CA (US); Xinlu YU, Palo Alto, CA (US); Tian XIA, Palo Alto, CA (US); Peng CHANG, Palo Alto, CA (US); Mei HAN, Palo Alto, CA (US); Jing XIAO, Palo Alto, CA (US)

(21) Appl. No.: 17/145,136

(22) Filed: Jan. 8, 2021

(51) Int. Cl. G09B 19/04; G10L 15/02; G10L 15/22; G10L 15/187; G10L 25/24; G10L 25/21; G10L 15/197; G10L 15/16; G10L 15/14; G09B 5/02

(52) U.S. Cl. CPC G09B 19/04; G10L 15/02; G10L 15/22; G10L 15/187; G10L 25/24; G10L 2015/025; G10L 15/197; G10L 15/16; G10L 15/142; G09B 5/02; G10L 25/21

(57) ABSTRACT

An English pronunciation assessment method includes: receiving an audio file including an English speech and a text transcript corresponding to the English speech; inputting audio signal to one or more acoustic models to obtain phonetic information of each phone in each word, wherein the one or more acoustic models are trained with speeches spoken by native speakers and further with speeches spoken by non-native speakers without labeling out mispronunciations, such that a pronunciation error is detected more accurately based on the obtained phonetic information; extracting time series features of each word; inputting the extracted time series features of each word, the obtained phonetic information of each phone in each word, and the audio signal included in the audio file to a lexical stress model to obtain misplaced lexical stress in each of words in the English speech with different number of syllables without expanding short words to cause input approximation.

### FIELD OF THE TECHNOLOGY

This application relates to the field of pronunciation assessment technologies and, more particularly, to method, device, and computer program product of English pronunciation assessment based on machine learning techniques.

### BACKGROUND OF THE DISCLOSURE

Non-native speakers often either mispronounce or misplace lexical stresses in their English speeches. They may improve their pronunciations through practices, i.e., making mistakes, receiving feedbacks, and making corrections. Traditionally, practicing English pronunciation requires interaction with a human English teacher. In addition to the human English teacher, computer aided language learning (CALL) systems may often be used to provide goodness of pronunciation (GOP) scores as feedbacks on the English speeches uttered by the non-native speakers. In this case, an audio recording of an English speech by the non-native speaker reciting an English text transcript is inputted into a pronunciation assessment system. The pronunciation assessment system assesses the English pronunciation of the non-native speaker and outputs words with pronunciation errors such as mispronunciations and misplaced lexical stresses. However, the accuracy and sensitivity of the computer aided pronunciation assessment system need to be improved.

The present disclosure provides an English pronunciation assessment method based on machine learning techniques. The method incorporates non-native English speech without labeling out mispronunciations into acoustic model training for generating GOP scores. The acoustic model also takes accent-based features as auxiliary inputs. In addition, time series features are inputted into the acoustic model to fully explore input information and accommodate words with different number of syllables. Thus, the accuracy and recall rate for detecting the mispronunciations and the misplaced lexical stresses are improved.

### SUMMARY

One aspect of the present disclosure includes a computer-implemented English pronunciation assessment method. The method includes: receiving an audio file including an English speech and a text transcript corresponding to the English speech; inputting audio signal included in the audio file to one or more acoustic models to obtain phonetic information of each phone in each word of the English speech, wherein the one or more acoustic models are trained with speeches spoken by native speakers and further with speeches spoken by non-native speakers without labeling out mispronunciations, such that a pronunciation error is detected more accurately based on the one or more acoustic models trained with speeches by both native and non-native speakers; extracting time series features of each word contained in the inputted audio signal to convert each word of varying length into a fixed length feature vector; inputting the extracted time series features of each word, the obtained phonetic information of each phone in each word, and the audio signal included in the audio file to a lexical stress model to obtain misplaced lexical stress in each of words in the English speech with different number of syllables without expanding short words to cause input approximation; and outputting each word with the pronunciation error at least corresponding to a lexical stress in the text transcript.

Another aspect of the present disclosure includes an English pronunciation assessment device. The device includes: a memory for storing program instructions; and a processor for executing the program instructions stored in the memory to perform: receiving an audio file including an English speech and a text transcript corresponding to the English speech; inputting audio signal included in the audio file to one or more acoustic models to obtain phonetic information of each phone in each word of the English speech, wherein the one or more acoustic models are trained with speeches spoken by native speakers and further with speeches spoken by non-native speakers without labeling out mispronunciations, such that a pronunciation error is detected more accurately based on the one or more acoustic models trained with speeches by both native and non-native speakers; extracting time series features of each word contained in the inputted audio signal to convert each word of varying length into a fixed length feature vector; inputting the extracted time series features of each word, the obtained phonetic information of each phone in each word, and the audio signal included in the audio file to a lexical stress model to obtain misplaced lexical stress in each of words in the English speech with different number of syllables without expanding short words to cause input approximation; and outputting each word with the pronunciation error at least corresponding to a lexical stress in the text transcript.

Another aspect of the present disclosure includes a computer program product including a non-transitory computer readable storage medium and program instructions stored therein, the program instructions being configured to be executable by a computer to cause the computer to perform operations including: receiving an audio file including an English speech and a text transcript corresponding to the English speech; inputting audio signal included in the audio file to one or more acoustic models to obtain phonetic information of each phone in each word of the English speech, wherein the one or more acoustic models are trained with speeches spoken by native speakers and further with speeches spoken by non-native speakers without labeling out mispronunciations, such that a pronunciation error is detected more accurately based on the one or more acoustic models trained with speeches by both native and non-native speakers; extracting time series features of each word contained in the inputted audio signal to convert each word of varying length into a fixed length feature vector; inputting the extracted time series features of each word, the obtained phonetic information of each phone in each word, and the audio signal included in the audio file to a lexical stress model to obtain misplaced lexical stress in each of words in the English speech with different number of syllables without expanding short words to cause input approximation; and outputting each word with the pronunciation error at least corresponding to a lexical stress in the text transcript.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary English pronunciation assessment method consistent with embodiments of the present disclosure;

FIG. 2 illustrates another exemplary English pronunciation assessment method consistent with embodiments of the present disclosure;

FIG. 3 illustrates an exemplary method of obtaining phonetic information of each phone in each word consistent with embodiments of the present disclosure;

FIG. 4 illustrates an exemplary method of detecting mispronunciations consistent with embodiments of the present disclosure;

FIG. 5 illustrates an exemplary method of detecting misplaced lexical stresses consistent with embodiments of the present disclosure;

FIG. 6 illustrates an exemplary time delayed neural network (TDNN) consistent with embodiments of the present disclosure;

FIG. 7 illustrates an exemplary factorized layer with semi-orthogonal constraint consistent with embodiments of the present disclosure;

FIG. 8 illustrates an exemplary state-clustered triphone hidden Markov model (HMM) consistent with embodiments of the present disclosure;

FIG. 9 illustrates an exemplary posterior probability acoustic model consistent with embodiments of the present disclosure;

FIG. 10 illustrates exemplary neural network structures for acoustic modeling for mispronunciation detection consistent with embodiments of the present disclosure;

FIG. 11 illustrates precision vs recall curves comparing various AMs consistent with embodiments of the present disclosure;

FIG. 12 illustrates an exemplary neural network structure for acoustic modelling for misplaced lexical stress detection consistent with embodiments of the present disclosure; and

FIG. 13 illustrates an exemplary English pronunciation assessment device consistent with embodiments of the present disclosure.

### DETAILED DESCRIPTION

The following describes the technical solutions in the embodiments of the present invention with reference to the accompanying drawings. Wherever possible, the same reference numbers will be used throughout the drawings to refer to the same or like parts. Apparently, the described embodiments are merely some but not all the embodiments of the present invention. Other embodiments obtained by a person skilled in the art based on the embodiments of the present invention without creative efforts shall fall within the protection scope of the present disclosure. Certain terms used in this disclosure are first explained in the followings.

Acoustic model (AM): an acoustic model is used in automatic speech recognition to represent the relationship between an audio signal and phones or other linguistic units that make up speech. The model is learned from a set of audio recordings and their corresponding transcripts, and machine learning software algorithms are used to create statistical representations of the sounds that make up each word.

Automatic speech recognition (ASR): ASR is a technology that converts spoken words into text.

Bidirectional encoder representations from transformers (BERT): BERT is a method of pre-training language representations.

Cross entropy (CE): the cross entropy between two probability distributions p and q over the same underlying set of events measures the average number of bits needed to identify an event drawn from the set if a coding scheme used for the set is optimized for an estimated probability distribution q, rather than the true distribution p.

Deep neural network (DNN): a DNN is an artificial neural network with multiple layers between the input and output layers for modeling complex non-linear relationships. DNNs are typically feedforward networks in which data flows from the input layer to the output layer without looping back.

Goodness of pronunciation (GOP): the GOP algorithm calculates the likelihood ratio that the realized phone corresponds to the phoneme that should have been spoken according to the canonical pronunciation.

Hidden Markov model (HMM): the HMM is a statistical Markov model in which the device being modeled is assumed to be a Markov process with unobservable states.

Lexical stress detection: the lexical stress detection is a deep learning model that identifies whether a vowel phoneme in an isolated word is stressed or unstressed.

Light gradient boosting machine (LightGBM): LightGBM is an open source gradient boosting framework for machine learning. It is based on decision tree algorithms and used for ranking and classification, etc.

Long short-term memory (LSTM): LSTM is an artificial recurrent neural network (RNN) architecture used in the field of deep learning.

Mel-frequency cepstrum coefficient (MFCC): the mel-frequency cepstrum is a representation of the short-term power spectrum of a sound, based on a linear cosine transform of a log power spectrum on a nonlinear mel scale of frequency. The MFCC are coefficients that collectively make up an MFC.

Mixture model (MM): a mixture model is a probabilistic model for representing the presence of subpopulations within an overall population, without requiring that an observed data set should identify the subpopulation to which an individual observation belongs. As one of the mixture models, a Gaussian mixture model is a probabilistic model that assumes all the data points are generated from a mixture of a finite number of Gaussian distributions with unknown parameters.

Multi-taking learning (MTL): MTL is a subfield of machine learning in which multiple learning tasks are solved simultaneously, while exploiting commonalities and differences across tasks. MTL can result in improved learning efficiency and prediction accuracy for task-specific models, when compared to training the models separately.

Mutual information (MI): MI of two random variables is a measure of the mutual dependence between the two variables. More specifically, it quantifies the amount of information obtained about one random variable through observing the other random variable.

One hot encoding (OHE): one hot encoding is often used for indicting the state of a state machine, which is in the n-th state if and only if the n-th bit is high.

Phone and phoneme: a phone is any distinct speech sound or gesture, regardless of whether the exact sound is critical to the meanings of words. In contrast, a phoneme is a speech sound in a given language that, if swapped with another phoneme, could change one word to another.

Senone: the senone is a subset of a phone and the senones are defined as tied states within context-dependent phones.

Time delay neural network (TDNN): TDNN is a multilayer artificial neural network architecture whose purpose is to classify patterns with shift-invariance and to model context at each layer of the network.

Universal background mode (UBM): UBM is a model often used in a biometric verification device to represent general, person-independent feature characteristics to be compared against a model of person-specific feature characteristics when making an accept or reject decision.

Word error rate (WER): WER is a measurement of speech recognition performance.

The present disclosure provides an English pronunciation assessment method. The method takes advantages of various machine learning techniques to improve the performance of detecting mispronunciations and misplaced lexical stresses in speeches spoken by non-native speakers.

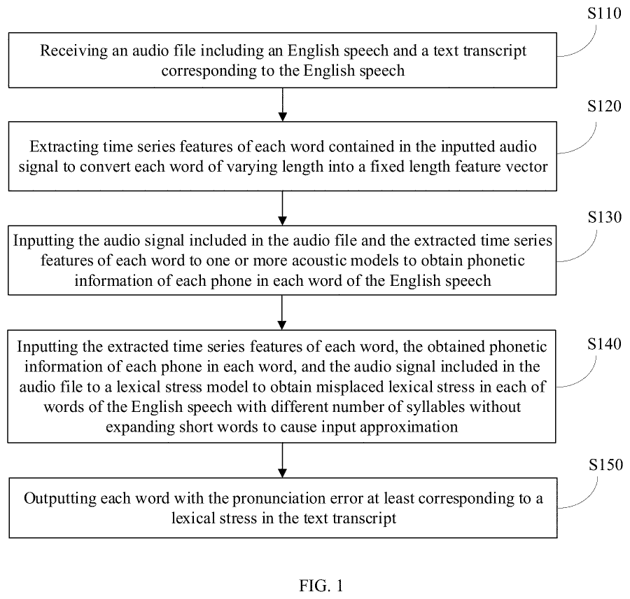

FIG. 1 illustrates an exemplary English pronunciation assessment method consistent with embodiments of the present disclosure. As shown in FIG. 1, an audio file including an English speech is received as an input along with a text transcript corresponding to the English speech (at S110).

The audio file includes an audio signal of a human speech. The audio signal is a time-varying signal. Generally, the audio signal is divided into a plurality of segments for audio analysis. Such segments are also called analysis frames or phonemes and are often in durations of 10 ms to 250 ms. Audio frames or phonemes are strung together to make words.

At S120, time series features of each word contained in the inputted audio file are extracted to convert each word of varying length into a fixed length feature vector.

Specifically, extracting the time series features includes windowing the audio signal into a plurality of frames, performing a discrete Fourier transform (DFT) on each frame, taking the logarithm of an amplitude of each DFT transformed frame, warping frequencies contained in the DFT transformed frames on a Mel scale, and performing an inverse discrete cosine transform (DCT).

The time series features may include frequency, energy, and Mel Frequency Cepstral Coefficient (MFCC) features. After the frequency, the energy, and the MFCC features are extracted, they are normalized at the word level and in each feature dimension. For example, the extracted features are linearly scaled into a range of minimum and maximum and are subtracted by a mean value.

At S130, the audio signal included in the audio file and the extracted time series features of each word are inputted to one or more acoustic models to obtain phonetic information of each phone in each word of the English speech. Specifically, the one or more acoustic models may be cascaded together.

In computer-aided pronunciation training, speech recognition related technologies are used to detect the mispronunciations and misplaced lexical stresses in a speech spoken by a non-native speaker. At a segmental level, the speech is analyzed to detect the mispronunciation of each phone in each word. At a suprasegmental level, the speech is analyzed to detect the misplaced lexical stress of each word.

Mispronunciation may include analogical (substitute), epenthesis (insertion), and metathesis (deletion) errors. Detecting the epenthesis and metathesis errors involves building extended recognition networks from phonological rules either summaries by English as a second language (ESL) teachers or automatically learned from data labeled by ESL teachers. The English pronunciation assessment method consistent with the embodiments of the present disclosure does not require the involvement of the ESL teachers. In this specification, the mispronunciation detection focuses on only analogical errors.

In the existing technology, an acoustic model (AM) for the mispronunciation detection is often trained with a native speaker dataset. The AM may also be trained further with a non-native speaker dataset. However, the mispronunciations in the non-native speaker dataset must be annotated by the ESL teachers, which limits the size of the non-native speaker dataset and hence provides less desirable accuracy.

In the embodiments of the present disclosure, a substantially large non-native speaker dataset (1700 hours of speeches) with mispronunciations is incorporated into the AM training together with the native speaker dataset to substantially improve the performance of the mispronunciation detection without requiring the ESL teachers to label the mispronunciations in the non-native speaker dataset.

In acoustic modeling for speech recognition, it is assumed to have training and testing with a matched condition. While in speech assessment, the baseline canonical AM trained on the training speeches by the native speakers has to be applied on mismatched testing speeches by the non-native speakers. In the embodiments of the present disclosure, accent-based embeddings and accent one hot encoding are incorporated in the acoustic modeling. The AM is trained in a multi-taking learning (MTL) fashion except that the speeches by the non-native speakers are intentionally treated as the speeches by the native speakers when extracting auxiliary features at an inference stage. This approach substantially improves the performance of the mispronunciation detection.

The AM often includes a feed-forward neural network, such as a time delay neural networks (TDNN) and a 1D dilated convolution neural networks with ResNet-style connections.

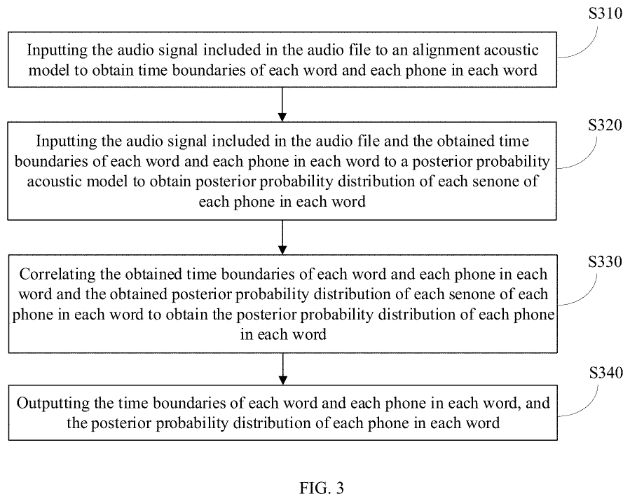

FIG. 3 illustrates an exemplary method of obtaining phonetic information of each phone in each word consistent with embodiments of the present disclosure. As shown in FIG. 3, inputting the audio signal included in the audio file to one or more acoustic models to obtain the phonetic information of each phone in each word of the English speech may include the following steps.

At S310, the audio signal included in the audio file is inputted into an alignment acoustic model to obtain time boundaries of each word and each phone in each word.

Specifically, the alignment acoustic model is used to determine the time boundaries of each phone and each word given the corresponding text transcript. The alignment acoustic model may include a combination of a Gaussian mixture model (GMM) and a hidden Markov model (HMM) or a combination of a neural network model (NNM) and the HMM.

The GMM is used to estimate density. It is made up of a linear combination of Gaussian densities:

f(x)=Σₘ₌₁^{M}αₘϕ(x; μₘ, Σₘ)

where αₘ is the mixing proportions with Σαₘ=1, and each ϕ(x; μₘ, Σₘ) is a Gaussian density with mean μₘ and covariance matrix Σₘ.

In one embodiment, the NNM is a factorized time delayed neural network (TDNN). The factorized TDNN (also known as TDNNF) uses sub-sampling to reduce computation during training. In the TDNN architecture, initial transforms are learned on narrow contexts and the deeper layers process the hidden activations from a wider temporal context. The higher layers have the ability to learn wider temporal relationship. Each layer in the TDNN operates at a different temporal resolution, which increases at higher layers of the neural network.

FIG. 6 illustrates an exemplary time delayed neural network (TDNN) consistent with embodiments of the present disclosure. As shown in FIG. 6, hidden activations are computed at all time steps at each layer, and dependencies between activations are across layers and localized in time. The hyper-parameters which define the TDNN network are the input contexts of each layer required to compute an output activation, at one time step. Layer-wise context specification corresponding to the TDNN is shown in Table 1.

TABLE 1

| | | Input context with |
|---|---|---|
| Layer | Input context | sub-sampling |
| 1 | [−2, +2] | {−2, 2} |
| 2 | [−1, 2] | {−1, 2} |
| 3 | [−3, 3] | {−3, 3} |
| 4 | [−7, 2] | {−7, 2} |
| 5 | {0} | {0} |

For example, in Table 1, the notation {−7, 2} means the network splices together the input at the current frame minus 7 and the current frame plus 2. As shown in FIG. 6, increasingly wider context may be spliced together ay higher layers of the network. At the input layer, the network splices together frames t−2 through t+2 (i.e., {−2, −1, 0, 1, 2} or more compactly [−2, 2]). At three hidden layers, the network splices frames at offsets {−1, 2}, {−3, 3}, and {−7, 2}. In Table 1, the contexts are compared with a hypothetical setup without sub-sampling in the middle column. The differences between the offsets at the hidden layers are configured to be multiples of 3 to ensure that a small number of hidden layer activations are evaluated for each output frame. Further, the network uses asymmetric input contexts with more context to the left, as it reduces the latency of the neural network in online decoding.

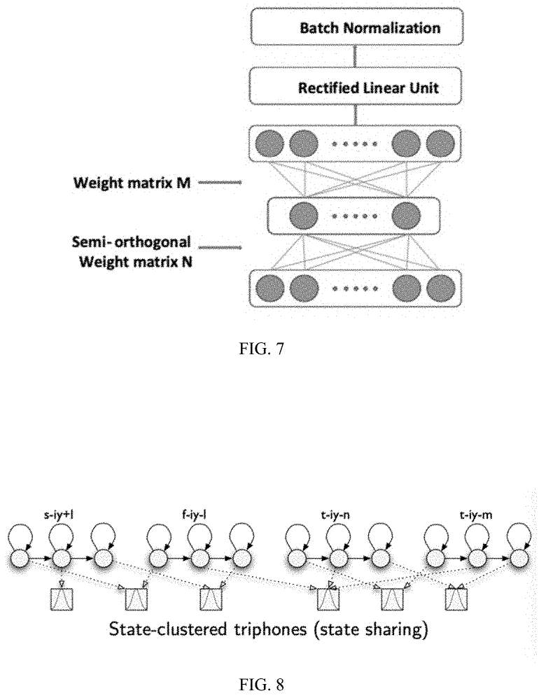

FIG. 7 illustrates an exemplary factorized layer with semi-orthogonal constraint consistent with embodiments of the present disclosure. As shown in FIG. 7, the TDNN acoustic model is trained with parameter matrices represented as the product of two or more smaller matrices, with all but one of the factors constrained to be semi-orthogonal, as such the TDNN becomes a factorized TDNN or TDNNF.

In one embodiment, the factorized convolution of each hidden layer is a 3-stage convolution. The 3-stage convolution includes a 2×1 convolution constrained to dimension 256, a 2×1 convolution constrained to dimension 256, and a 2×1 convolution back to the hidden layer constrained to dimension 1536. That is, 1536=>256=>256=>1536 within one layer. The effective temporal context is wider than the TDNN without the factorization due to the extra 2×1 convolution. A dropout rises from 0 at the start of training to 0.5 halfway through, and 0 at the end. The dropout is applied after the ReLU and batchnorm.

In one embodiment, the HMM is a state-clustered triphone model for time series data with a set of discrete states. The triphone HMM models each phone with three distinct states. A phonetic decision tree is used to cluster similar states together. The triphone HMM naturally generates an alignment between states and observations. The neural network model or the Gaussian mixture model estimates likelihoods. The triphone HMM uses the estimated likelihoods in Viterbi algorithm to determine the most probable sequence of the phones.

FIG. 8 illustrates an exemplary state-clustered triphone hidden Markov model (HMI) consistent with embodiments of the present disclosure. As shown in FIG. 8, state-clustered triphones are used to model the phonetic context of a speech unit, where the place of articulation for one speech sound depends on a neighboring speech sound. Longer units that incorporate context, or multiple models for each context or context-dependent phone models may be used to model context. For triphones, each phone has a unique model for each left and right context. A phone x with left context 1 and right context r may be represented as 1−x+r.

Context-dependent models are more specific than context-independent models. As more context-dependent models are defined, each one becomes responsible for a smaller region of the acoustic-phonetic space. Generally, the number of possible triphone types is much greater than the number of observed triphone tokens. Techniques such as smoothing and parameter sharing are used to reduce the number of the triphones. Smoothing combines less-specific and more-specific models. Parameter sharing makes different contexts share models. Various examples of smoothing and parameter sharing are described below.

In one example, as a type of smoothing, backing off uses a less-specific model when there is not enough data to train a more specific model. For example, if a triphone is not observed or few examples are observed, a biphone model may be used instead of a triphone model. If the biphone occurrences are rare, the biphone may be further reduced to a monophone. A minimum training example count may be used to determine whether a triphone is modelled or backed-off to a biphone. This approach ensures that each model is well trained. Because training data is sparse, relatively few specific triphone models are actually trained.

In another example, as another type of smoothing, interpolation combines less-specific models with more specific models. For example, the parameters of a triphone are interpolated with the parameters of a biphone λ^{bi}, and a monophone λ^{mono}, that is, \hat{λ}^{tri}=α₃λ^{tri}+α₂λ^{bi}+α₁λ^{mono}. The interpolation parameters α₁, α₂, and α₃ are estimated based on deleted interpolation. Interpolation enables more triphone models to be estimated and also adds robustness by sharing data from other contexts through the biphone and monophone models.

In another example, parameter sharing explicitly shares models or parameters between different contexts. Sharing may take place at different levels. At Gaussian level, all distributions share the same set of Gaussians but have different mixture weights (i.e., tied mixtures). At state level, different models are allowed to share the same states (i.e., state clustering). In the state clustering, states responsible for acoustically similar data are shared. By clustering similar states, the training data associated with individual states may be pooled together, thereby resulting in better parameter estimates for the state. Left and right contexts may be clustered separately. At model level, similar context-dependent models are merged (i.e., generalized triphones). Context-dependent phones are termed allophones of the parent phone. Allophone models with different triphone contexts are compared and similar ones are merged. Merged models may be estimated from more data that individual models, thereby resulting in more accurate models and fewer models in total. The merged models are referred to as generalized triphones.

Further, phonetic decision trees are used in clustering states. A phonetic decision tree is built for each state of each parent phone, with yes/no questions at each node. At the root of the phonetic decision tree, all states are shared. The yes/no questions are used to split the pool of states. The resultant state clusters become leaves of the phonetic decision tree. The questions at each node are selected from a large set of predefined questions. The questions are selected to maximize the likelihood of the data given the state clusters. Splitting terminates when the likelihood does not increase by more than a predefined likelihood threshold, or the amount of data associated with a split node are less than a predefined data threshold.

The likelihood of a state cluster is determined as follows. At first, a log likelihood of the data associated with a pool of states is computed. In this case, all states are pooled in a single cluster at the root, and all states have Gaussian output probability density functions. Let S={s₁, s₂, . . . , s_{K}} be a pool of K states forming a cluster, sharing a common mean μₛ and covariance Σₛ. Let X be the set of training data. Let γₛ(x) be the probability that x∈X was generated by state s, that is, state occupation probability. Then, the log likelihood of the data associated with cluster S is:

L(S)=Σ_{s∈S}Σ_{x∈X} log P(x|μₛ)γₛ(x)

Further, the likelihood calculation does not need to iterate through all data for each state. When the output probability density functions are Gaussian, the log likelihood can be:

L(S)=−½(log((2π)^{d}|Σₛ|)+d) Σ_{s∈S}Σ_{x∈X}γₛ(x)

where d is the dimension of the data. Thus, L (S) depends on only the pooled state variance Σₛ, which is computed from the means and variances of the individual states in the pool and the state occupation probabilities are already computed when forward-backward was carried out.

The splitting questions are selected based on the likelihood of the parent state and the likelihood of the split states. The question about the phonetic context is intended to split S into two partitions S_{y} and Sₙ. Partition S_{y} is now clustered together to form a single Gaussian output distribution with mean μ_{S}_{_{y}} and covariance Σ_{S}_{_{y}}, and partition Sₙ is now clustered together to form a single Gaussian output distribution with mean Σ_{S}_{_{y}}, and covariance Σ_{S}_{ₙ}. The likelihood of the data after the partition is L(S_{y})+L(Sₙ). The total likelihood of the partitioned data increases by Δ=L(S_{y})+L(Sₙ)−L(S). The splitting questions may be determined by cycling through all possible questions, computing Δ for each and selecting the question for which Δ is the greatest.

Splitting continues for each of the new clusters S_{y} and Sₙ until the greatest Δ falls below the predefined likelihood threshold or the amount of data associated with a split node falls below the predefined data threshold. For a Gaussian output distribution, state likelihood estimates may be estimated using just the state occupation counts (obtained at alignment) and the parameters of the Gaussian. Acoustic data is not needed. The state occupation count is a sum of state occupation probabilities for a state over time.

The above described state clustering assumes that the state outputs are Gaussians, which makes the computations much simple. However, Gaussian mixtures offer much better acoustic models than Gaussians. In one embodiment, the HMM-based device based on Gaussian distributions may be transformed to one based on mixtures of Gaussians. The transformation may include performing state clustering using Gaussian distributions, splitting the Gaussian distributions in the clustered states by cloning and perturbing the means by a small fraction of the standard deviation and then retraining, and repeating by splitting the dominant (highest state occupation count) mixture components in each state.

Returning to FIG. 3, at S320, the audio signal included in the audio file and the obtained time boundaries of each word and each phone in each word are inputted to a posterior probability acoustic model to obtain posterior probability distribution of each senone of each phone in each word.

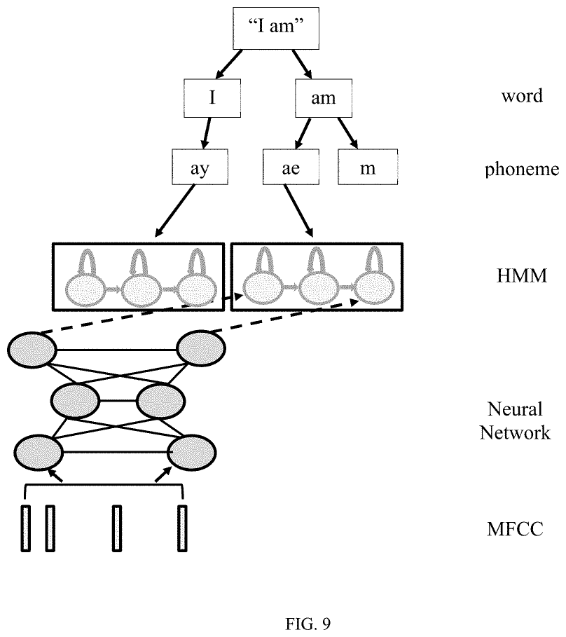

The posterior probability acoustic model may be the same as the alignment acoustic model with different inputs and outputs. Specifically, the posterior probability acoustic model is the combination of the neural network mode and the HMM model. FIG. 9 illustrates an exemplary posterior probability acoustic model consistent with embodiments of the present disclosure. As shown in FIG. 9, the neural network and the HMM are cascaded to form the posterior probability acoustic model. Because the neural network in FIG. 9 is the same as the TDNNF in the alignment acoustic model in FIG. 6, the detail description is omitted. Similarly, because the HMM in FIG. 9 is the same as the HMM in the alignment acoustic model in FIG. 6, the detail description is omitted.

Unlike the alignment acoustic model, the input to the posterior probability acoustic model includes the audio signal aligned with the time boundaries and the MFCC features that have been extracted from the audio signal at S120, and the output from the posterior probability acoustic model includes the posterior probability distribution of each senone of each phone in each word.

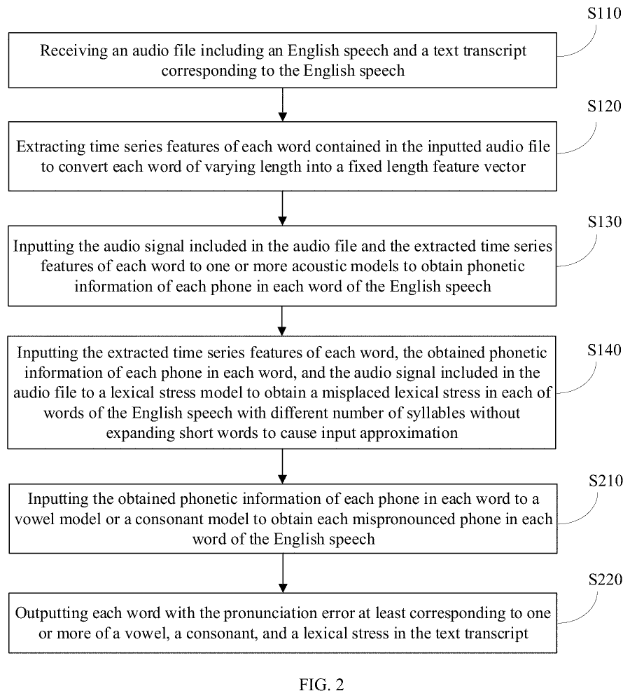

Returning to FIG. 2, at S330, the obtained time boundaries of each word and each phone in each word and the posterior probability distribution of each senone of each phone in each word are correlated to obtain the posterior probability distribution of each phone in each word. Subsequently, at S340, the time boundaries of each word and each phone in each word, and the posterior probability distribution of each phone in each word are outputted for further processing. Specifically, the time boundaries of each word and each phone in each word, and the posterior probability distribution of each phone in each word will be used in detecting mispronunciations and misplaced lexical stresses in the speeches spoken by the non-native speaker, respectively. The acoustic models for detecting mispronunciations and misplaced lexical stresses in the speech spoken by the non-native speaker will be described in detail below.

Returning to FIG. 1, at S140, the extracted time series features of each word, the obtained phonetic information of each phone in each word, and the audio signal included in the audio file are inputted to a lexical stress mode to obtain a misplaced lexical stress in each of words of the English speech with different number of syllables without expanding short words to cause input approximation. As shown in FIG. 1, after the mispronunciations are detected, the method detects the misplaced lexical stresses in the English speech.

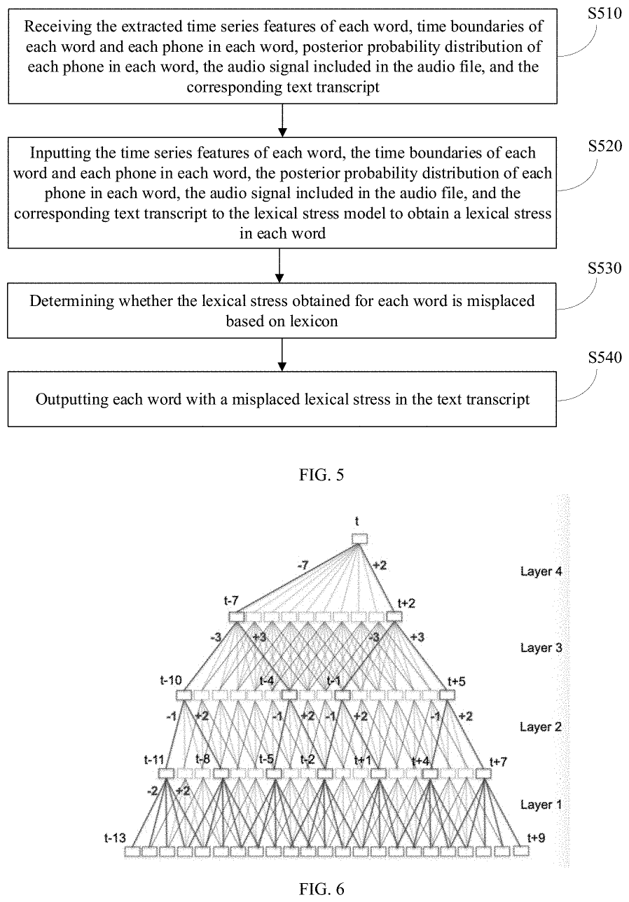

FIG. 5 illustrates an exemplary method of detecting misplaced lexical stresses consistent with embodiments of the present disclosure. As shown in FIG. 5, at S510, the extracted time series features of each word, the time boundaries of each word and each phone in each word, posterior probability distribution of each phone in each word, the audio signal included in the audio file, and the corresponding text transcript are received. The time series features of each word may be extracted at S120 in FIG. 1. The time boundaries of each word and each phone in each word may be obtained at S310 in FIG. 3. The posterior probability distribution of each phone in each word may be obtained at S330 in FIG. 3.

At S520, the time series features of each word, the time boundaries of each word and each phone in each word, the posterior probability distribution of each phone in each word, the audio signal included in the audio file, and the corresponding text transcript are inputted to the lexical stress model to obtain a lexical stress in each word.

Lexical stress has a relationship with the prominent syllables of a word. In many cases, the position of syllable carries important information to disambiguate word semantics.

For example, “subject” and “sub'ject”, and “permit” and “per'mit” have totally different meanings. After the lexical stress of a word is detected, the result is compared with its typical lexical stress pattern from an English dictionary to determine whether the lexical stress of the word is misplaced.

In one embodiment, the lexical stress detection process includes an inner attention processing. Combined with the LSTM machine learning technique, the inner attention processing is used to model time series features by extracting important information from each word of the inputted speech and converting the length-varying word into a fixed length feature vector.

In the process of extracting the time series features, multiple highest frequencies or pitches are extracted from each audio frame. As stressed syllable exhibits higher energy than its neighboring ones, energy is also extracted from each audio frame. In addition, Mel Frequency Cepstral Coefficient (MFCC) features with Delta and Delta-Delta information are extracted by performing a dimensionality reduction for each frame. A large dimension is preferred when extracting the MFCC features.

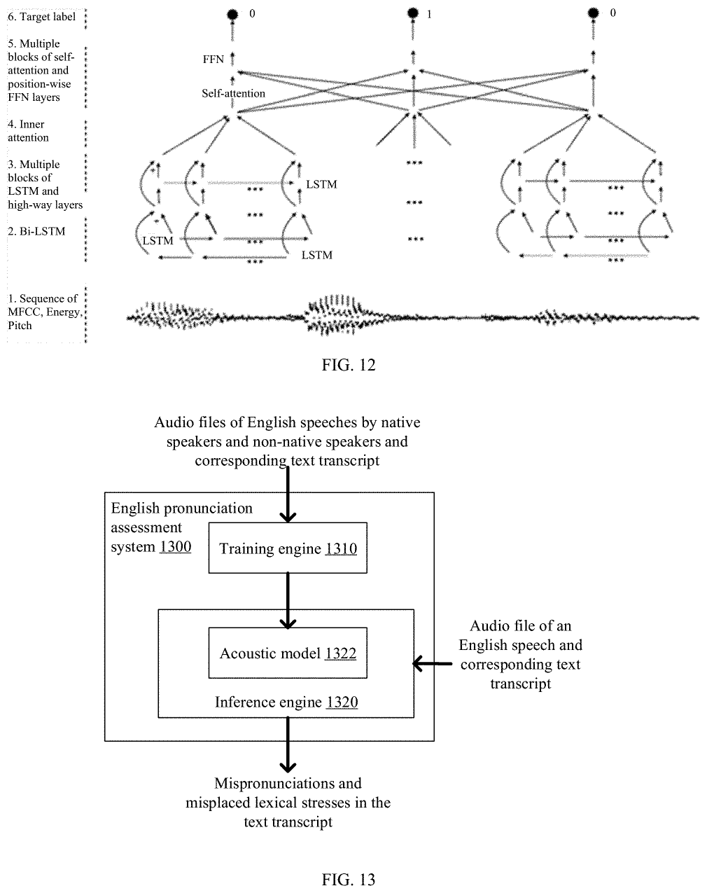

FIG. 12 illustrates an exemplary neural network structure for acoustic modelling for misplaced lexical stress detection consistent with embodiments of the present disclosure. As shown in FIG. 12, the word “projector” is partitioned into three syllables by linguistic rules, “pro”, “jec”, and “tor”. Represented as concatenation of several time-series features (e.g., MFCC, pitch, and energy) at the frame level, each syllable is encoded by LSTM blocks and then converted into a fixed-length feature vector by the inner attention processing. After each syllable in the word is processed, all syllable-representing feature vectors are interacting with each other by the self-attention and are trained to fit their final labels. In this case, all LSTM models share same parameters and all position-wise feed-forward-networks (FFN) share same parameters as well.

As shown in FIG. 12, the neural network structure for the lexical stress model includes six logic levels. The logic levels 2, 3, and 4 illustrate the internal structure of a syllable encoding module, which includes one block of bidirectional LSTM, several blocks of unidirectional LSTM and residual edge, and one inner attention processing layer. The bi-directional LSTM is a type of recurrent neural network architecture used to model sequence-to-sequence problems. In this case, the input sequences are time-dependent features (time series) and the output sequence is the syllable-level lexical stress probabilities.

Based on the statistics of syllable duration, the maximum LSTM steps are limited to 50, which corresponds to 500ms duration. As shown in FIG. 12, the nodes at the logic levels 2 and 3 represent the LSTM cell states at different time steps. At the logic level 2, two frame-level LSTMs run in two opposite directions and aggregate together element-wisely to enrich both the left and right context for each frame state. The logic level 3 includes multiple identical blocks. Each block has a unidirectional LSTM and aggregates its input element-wisely into its output via a residual edge. The horizontal arrows at the logic levels 2 and 3 indicate the directional connections of the cell states in the respective LSTM layer. The bidirectional LSTM contains two LSTM cell state sequences: one with forward connections (from left to right) and the other with backward connections (from right to left). In the output, the two sequences are summed up element-wise to serve as the input sequence to the next level (indicated by the upward arrows). The logic level 4 includes the inner attention processing as a special weighted-pooling strategy. Because the durations of syllables vary substantially and the maximum number of LSTM steps (or the maximum frame number) is limited, only real frame information is weighted and filled frame information is ignored, as shown in the equations below.

$${α}_{i} = \{ \begin{matrix}softmax \{ f ( S , H ) \} , & i ∈ [ 0 , syllable\_length ) \\ 0 , & i ∈ [ syllable\_length , 50 )\end{matrix} S = \sum {α}_{i} \cdot {S}_{i}$$

where Sᵢ is the state vector of LSTM, corresponding to each speech frame, H is a global and trainable vector shared by all syllables, the function f defines how to compute the importance of each state vector by its real content. For example, the simplest definition of the function f is the inner product.

In one embodiment, the lexical stress detection process further includes a self-attention technique. The self-attention technique intrinsically supports words with different numbers of syllables and is used to model contexture information.

As shown in FIG. 12, the logic level 5 illustrates the internal structure of a syllable interaction module, which includes a self-attention based network for digesting words with different number of syllables without expanding input by filling empty positions. The logic level 5 includes two parts: O(n²) operations of self-attention and O(n) operations of position-wise feed forward network. In the self-attention part, a bi-linear formula is adopted for the attention weight α_{i,j} and the matrix M is a globally trainable parameter. The bilinear formula is simple to implement and focused on the whole network structure itself. Alternatively, the attention weight α_{i,j} may be calculated by multi-head attention in BERT model. The self-attention processing is represented by the equations below.

α_{i,j}=softmax{Sᵢ^{T}MSⱼ}

Sᵢ=Σⱼα_{i,j}·Sⱼ

The position-wise feed forward network includes two dense networks. One network includes a relu activation function and the other network does not include the relu activation function. The position-wise feed forward network is represented by the equation below.

FFN(x)=max(0, xW₁+b₁)W₂+b

At the logic level 6, scores of 1, 0.5, and 0 are assigned to target labels as primary stress, secondary stress, and no stress, respectively. each target label corresponds to one syllable.

For example, the word “projector” has 3 syllables, and the target labels may be 0, 1, 0. The label scores are converted into a probability distribution via /1-norm. The probability distribution is then used in a cross-entropy based loss function. It should be noted that one word may have more than one primary stress. Thus, it is not a multi-class problem, but a multi-label problem. The loss function is represented in the equation below.

L=Σ_{syl}p_{syl}^{label} log P_{syl}^{o}

where p_{syl}^{label} is the normalized target label probability of a syllable, and P_{syl}^{o} is the corresponding output probability from the self-attention blocks.

The training dataset and the testing dataset for the above described acoustic model include two public datasets and one proprietary dataset. One of the two public datasets is Libri Speech dataset. 360 hours of clean read English speech are used as the training dataset and 50 hours of the same are used as the testing dataset. The other of the two public datasets is TedLium dataset. 400 hours of talk set with a variety of speakers and topics are used as the training dataset and 50 hours of the same are used as the testing dataset. The proprietary dataset is a dictionary based dataset. 2000 vocabularies spoken by 10 speakers are recorded. Most of them have three and four syllables. Each word is pronounced and recorded three times. Among the 10 speakers, 5 speakers are male and 5 speakers are female. The proprietary dataset includes 6000 word-based samples in total. Half of the 6000 samples include incorrect lexical stress.

At the inference stage, the lexical stress detection model is used to detect misplaced lexical stress at the word level. The detection results are F-values, which balances the precision rate and recall rate.

Specifically, the inputted audio signal is decoded by an automatic speech recognizer (ASR) to extract syllables from the phoneme sequence. Then, the features such as duration, energy, pitches, and MFCC are extracted from each syllable. Because the absolute duration of a same syllable within a word may vary substantially from person to person, the duration is measured relatively of each syllable in the word. The same approach is applied to other features. The features are extracted at the frame level and normalized at the word boundary to compute the relative value thereof. Values of 25% percentile, 50% percentile, 75% percentile, the minimum, and the maximum are obtained within the syllable window. The dimension of MFCC is set to 40. The dimension of additional delta and delta-delta information is set to 120.

The attention based network model for the lexical stress detection directly extracts the time series features frame by frame including the energy, the frequency, and the MFCC features, but excluding the duration. The model is implemented in Tensorflow and the optimizer is Adam with default hyper parameters. The learning rate is 1e-3. After at least 10 epoch of training, the model reaches a desired performance. The performance result (i.e., F-values) of the attention based network model is compared with two baseline models including a SVM based model and a gradient-boosting tree model in the Table 2.

TABLE 2

| | | #syllable | | | | |
|---|---|---|---|---|---|---|
| | | = | | | | |
| Dataset | Model | all | 2 | 3 | 4 | 5 |
| LibriSpeech | SVM | 0.80 | 0.822 | 0.783 | 0.730 | 0.652 |
| | Boosting | 0.85 | 0.874 | 0.834 | 0.784 | 0.708 |
| | Model | 0.95 | 0.9619 | 0.9138 | 0.8304 | 0.7232 |
| TedLium | SVM | 0.812 | 0.834 | 0.779 | 0.739 | 0.661 |
| | Boosting | 0.862 | 0.888 | 0.831 | 0.813 | 0.732 |
| | Model | 0.951 | 0.9669 | 0.9438 | 0.8804 | 0.7832 |
| Dictionary | SVM | 0.69 | 0.712 | 0.682 | 0.682 | 0.643 |
| | Boosting | 0.726 | 0.734 | 0.721 | 0.712 | 0.654 |
| | Model | 0.788 | 0.821 | 0.777 | 0.762 | 0.723 |

As can be seen from the Table 2, the attention based network model outperforms the two baseline models. Constructing an even larger proprietary dataset may further improve the performance.

In some embodiments, the model performances with different numbers of the LSTM blocks (or layers) are explored. The Table 3 shows that more LSTM blocks at the logic level 3 in FIG. 12 improve the performances until the number of the LSTM blocks reaches five. In this case, the number of the self-attention blocks is set to one. On the other hand, more LSTM blocks make the training substantially slower.

TABLE 3

| #LSTM | 1 | 2 | 3 | 4 | 5 | 6 |
|---|---|---|---|---|---|---|
| LibriSpeech | 0.920 | 0.928 | 0.939 | 0.944 | 0.951 | 0.948 |
| Dictionary | 0.743 | 0.751 | 0.760 | 0.768 | 0.770 | 0.764 |

In some embodiments, the model performances with different numbers of the self-attention blocks (or layers) are explored. The Table 4 shows that more self-attention blocks at the logic level 5 in FIG. 12 does not improve the performances due to potential overfitting. In this case, the number of the LSTM block is set to five.

TABLE 4

| #self-attention | 0 | 1 | 2 |
|---|---|---|---|
| LibriSpeech | 0.941 | 0.951 | 0.929 |
| Dictionary | 0.743 | 0.770 | 0.760 |

At S530, whether the lexical stress obtained for each word is misplaced is determined based on lexicon. Specifically, the lexicon may be an English dictionary, and the lexical stress obtained for each word may be compared with the lexical stress defined in the English dictionary. If the lexical stress obtained for each word is different from the lexical stress defined in the English dictionary, the corresponding word is determined to contain a misplaced lexical stress. When more than one lexical stress is defined in the English dictionary, a match between the lexical stress obtained for each word and any one of the more than one lexical stress defined in the English dictionary may be treated as no misplaced lexical stress found.

At S540, each word with a misplaced lexical stress is outputted in the text transcript.

Returning to FIG. 1, at S150, each word with the pronunciation error at corresponding to a lexical stress is outputted in the text transcript. Specifically, the text transcript may be displayed to the user and the misplaced lexical stresses are highlighted in the text transcript. Optionally, statistic data about the lexical stresses for the text transcript may be presented to the user in various formats. The present disclosure does not limit the formats of presenting the misplaced lexical stresses.

In the embodiments of the present disclosure, the acoustic model for detecting the mispronunciations is trained with a combination of the speeches spoken by native speakers and speeches spoken by non-native speakers without labeling out mispronunciations. In addition, accent-based features

In the embodiments of the present disclosure, the acoustic model for detecting the misplaced lexical stresses takes time series features as input to fully explore input information. The network structure of the acoustic model intrinsically adapts to words with different number of syllables, without expanding short words, thereby reducing input approximation. Thus, the detection precision is improved.

Further, the English pronunciation assessment method detects the mispronunciations. FIG. 2 illustrates another exemplary English pronunciation assessment method consistent with embodiments of the present disclosure. As shown in FIG. 2, S150 in

FIG. 1 is replaced with S210 and S220.

At S210, the obtained phonetic information of each phone in each word is inputted to a vowel model or a consonant model to obtain each mispronounced phone in each word of the English speech.

Specifically, the vowel model and the consonant model may be used to determine whether a vowel or a consonant is mispronounced, respectively. The phonetic information includes the audio signal aligned with the time boundaries of each phone in each word of the English speech and the posterior probability distribution of each phone in each word of the English speech. The mispronunciation detection will be described in detail below.

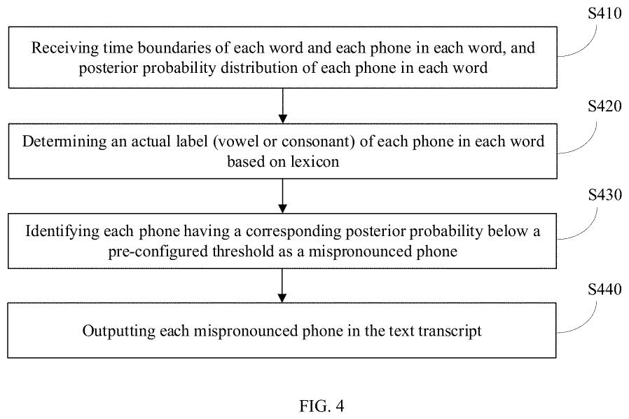

FIG. 4 illustrates an exemplary method of detecting mispronunciations consistent with embodiments of the present disclosure. As shown in FIG. 4, at S410, the time boundaries of each word and each phone in each word, the posterior probability distribution at the phonetic level, and the corresponding text transcript are received. Specifically, the output of S130 in FIG. 1 is the input of S410 in FIG. 4.

At S420, an actual label (vowel or consonant) of each phone in each word is determined based on lexicon. Specifically, the acoustic model for detecting the mispronunciation of the vowel or the consonant may be the same. Knowing whether each phone is a vowel or a consonant does not make a substantial difference even if the knowledge is given in the lexicon. The lexicon may also be considered as an English pronunciation dictionary.

At S430, each phone having a corresponding posterior probability below a pre-configured threshold is identified as a mispronounced phone. Specifically, the posterior probability of each phone is calculated based on the posterior probability acoustic model described in the description for FIG. 3.

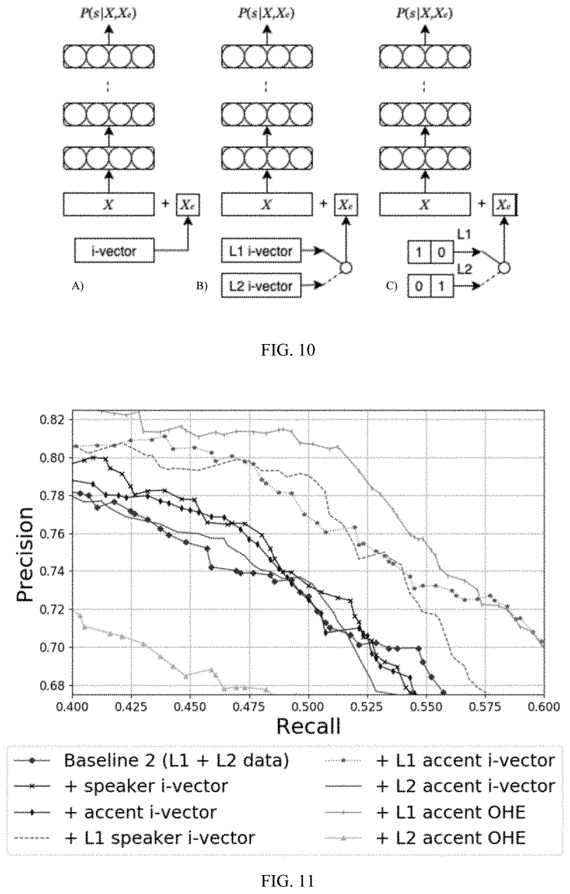

FIG. 10 illustrates exemplary neural networks for acoustic modeling for mispronunciation detection consistent with embodiments of the present disclosure. As shown in FIG. 10, X represents frame level MFCC, and Xe represents the auxiliary features. FIG. 10A is the neural network structure for the i-vector extractor. The i-vector extractor may be either speaker-based or accent-based. The switch in FIG. 10B and FIG. 10C is used to select only one auxiliary input. FIG. 10B is the neural network structure for either the homogeneous speaker i-vector extractor or the accent i-vector extractor. FIG. 10C is the neural network structure using accent one hot encoding.

i-vector is commonly used for speaker identification and verification. It is also effective as speaker embedding for the AM in speech recognition task. In one embodiment, a modified version allows i-vector to be updated with a fixed pace, i.e., “online i-vector”.

For each frame of feature extracted from the training dataset or the testing dataset, speaker i-vectors are concatenated to MFCCs as auxiliary network input as shown in FIG. 6a.

Training an accent i-vector extractor is the same as the speaker i-vector extractor except that the all speaker labels are replaced with their corresponding accent labels which are either native or non-native. At the inference stage, the accent i-vector is used the same way as the speaker i-vector shown in FIG. 10A.

It should be noted that the mispronunciation detection is only performed on non-native speeches. This information is used for training a homogeneous speaker i-vector.

In one embodiment, at the training stage, a universal background mode (UBM) is trained by both the native speech and the non-native speech to collect sufficient statistics. The UBM is then used to train a homogeneous speaker i-vector extractor of speakers on only native speeches. The extractor is called an L1 speaker i-vector extractor. An L2 speaker i-vector extractor may be trained in the same way except that only non-native speeches are used. Different from the speaker i-vector extractor which uses heterogeneous data with both native and non-native accents in training, the training of a homogeneous speaker i-vector extractor only uses homogeneous data with one accent.

In one embodiment, at the inference stage, only one -vector extractor is needed to be selected as the auxiliary feature extractor to the neural network structure shown in FIG. 10B. In this case, the L1 speaker i-vector extractor is used for all non-native speeches. That is, non-native speakers are intentionally treated as native speakers at the inference stage. As such, the performance of the mispronunciation detection is improved as compared with the using the L2 speaker i-vector extractor. It should be noted that matching between the type of the i-vector extractor and the type of speeches is required in the speech recognition application. However, mismatching between the type of the i-vector extractor and the type of speeches helps improve the performance of the mispronunciation detection, which needs discriminative GOP scores.

Because speakers of the same accent are grouped together at the training stage, the homogeneous speaker i-vector may also be regarded as an implicit accent representation. For homogeneous accent i-vector of native speech, i.e., the L1 accent i-vector, every procedure and configuration are the same as that of the L1 speaker i-vector except that all the speaker labels are replaced with only one class label, i.e., native. The non-native case is the same.

In one embodiment, the L1 and L2 accent one hot encodings (OHE) are defined as [1, 0] and [0, 1], respectively. For each frame of feature extracted from the native speeches in the training dataset, the L1 OHEs are concatenated to the MFCC features as shown in FIG. 10C, respectively.

In one embodiment, the L1 accent OHE is used for the non-native speech in the mispronunciation detection. The reason is the same as for the case of the homogeneous accent or speaker i-vector. The trainer acknowledges there are native and non-native data, and learns from the data with their speaker or accent labels on them, while the inferencer uses the trained model and labels every input data as native.

In one embodiment, x-vector or a neural network activation based embedding may also be used replacing the i-vector.

The training dataset and the testing dataset are summarized in the Table 5. k means in thousands. The testing dataset includes 267 read sentences and paragraphs by 56 non-native speakers. On average, each recording includes 26 words. The entire testing dataset includes 10, 386 vowel samples, in which 5.4% are labeled as analogical mispronunciations. The phones that are mispronounced as are not labeled.

TABLE 5

| | Hours | Speeches | Speakers |
|---|---|---|---|
| Native training dataset A | 452 | 268k | 2.3k |
| Native training dataset B | 1262 | 608k | 33.0k |
| Non-native training dataset | 1696 | 1430k | 6.0k |
| Non-native testing dataset | 1.1 | 267 | 56 |

The AM for the mispronunciation detection is a ResNet-style TDNN-F model with five layers. The output dimension of the factorized and TDNN layers is set to 256 and 1536, respectively. The final output dimension is 5184. The initial and final learning rates are set to 1e-3 and 1e-4, respectively. The number of epochs is set to 4. No dropout is used. The dimensions of accent/speaker i-vectors are set to 100. 60 k speeches from each accent are used for i-vector training.

FIG. 11 illustrates precision vs recall curves comparing various AMs consistent with embodiments of the present disclosure. As shown in FIG. 11, at a recall of 0.50, the precision increases from 0.58 to 0.74 after the non-native speeches are included in the training dataset. The precision increases further to 0.77 after the L1 homogeneous accent i-vector is included as the auxiliary feature for the acoustic modeling. The precision eventually increases to 0.81 after the L1 accent one hot encoding is included as the auxiliary feature for the acoustic modeling.

In one embodiment, the neural network structure for the acoustic modeling for the mispronunciation detection includes factorized feed-forward neural networks, i.e., TDNN-F. Alternatively, more sophisticated networks like RNN or sequence-to-sequence model with attention may be used. The accent OHE almost adds no extra computational cost compared to the baseline because it only introduces two extra dimensions as input.

At S440, after each mispronounced phone is identified, each mispronounced phone is outputted in the text transcript.

Returning to FIG. 2, at S220, each word with the pronunciation error at least corresponding to one or more of a vowel, a consonant, and a lexical stress is outputted in the text transcript. Specifically, the text transcript may be displayed to the user and the words with the pronunciation errors corresponding to one or more of a vowel, a consonant, and a lexical stress are highlighted in the text transcript. Optionally, statistic data about the pronunciation errors for the text transcript may be presented to the user in various formats. The present disclosure does not limit the formats of presenting the mispronunciations.

In the embodiments of the present disclosure, the acoustic model for detecting the mispronunciations is trained with a combination of the speeches spoken by native speakers and speeches spoken by non-native speakers without labeling out mispronunciations, which substantially improves the mispronunciation detection precision from 0.58 to 0.74 at a recall rate of 0.5. The accent-based features are inputted into the acoustic model as auxiliary inputs, and the accent one hot encoding is used to further improve the detection precision to 0.81 on the proprietary test dataset and to prove its generalizability by improving the detection precision by 6.9% relatively on a public L2-ARCTIC test dataset using the same acoustic model trained from the proprietary dataset.

The present disclosure also provides an English pronunciation assessment device. The device examines a speech spoken by a non-native speaker and provides a pronunciation assessment at a phonetic level by identifying mispronounced phones and misplaced lexical stresses to a user. The device further provides an overall goodness of pronunciation (GOP) score. The device is able to adapt to various accents of the non-native speakers and process long sentences up to 120 seconds.

FIG. 13 illustrates an exemplary English pronunciation assessment device consistent with embodiments of the present disclosure. As shown in FIG. 13, the English pronunciation assessment device 1300 includes a training engine 1310 and an inference engine 1320. At a training stage, the training engine 1310 uses the speeches spoken by native speakers, the speeches spoken by non-native speakers, and the corresponding text transcript to train an acoustic model 1322. At an inference stage, the inference engine 1320 uses an audio file of an English speech that needs to be assessed and a corresponding text transcript as input to the acoustic model. The inference engine 1320 outputs mispronunciations and misplaced lexical stresses in the text transcript.

The English pronunciation assessment device 1300 may include a processor and a memory. The memory may be used to store computer program instructions. The processor may be configured to invoke and execute the computer program instructions stored in the memory to implement the English pronunciation assessment method.

In one embodiment, the processor is configured to receive an audio file including an English speech and a text transcript corresponding to the English speech, input audio signal included in the audio file to one or more acoustic models to obtain phonetic information of each phone in each word of the English speech, where the one or more acoustic models are trained with speeches spoken by native speakers and further with speeches spoken by non-native speakers without labeling out mispronunciations, such that a pronunciation error is detected more accurately based on the one or more acoustic models trained with speeches by both native and non-native speakers, extract time series features of each word contained in the inputted audio signal to convert each word of varying length into a fixed length feature vector, input the extracted time series features of each word, the obtained phonetic information of each phone in each word, and the audio signal included in the audio file to a lexical stress model to obtain misplaced lexical stress in each of words in the English speech with different number of syllables without expanding short words to cause input approximation, and output each word with the pronunciation error at least corresponding to a lexical stress in the text transcript.

In one embodiment, the processor is configured to receive an audio file including an English speech and a text transcript corresponding to the English speech, input audio signal included in the audio file to one or more acoustic models to obtain phonetic information of each phone in each word of the English speech, where the one or more acoustic models are trained with speeches spoken by native speakers and further with speeches spoken by non-native speakers without labeling out mispronunciations, such that a pronunciation error is detected more accurately based on the one or more acoustic models trained with speeches by both native and non-native speakers, extract time series features of each word contained in the inputted audio signal to convert each word of varying length into a fixed length feature vector, input the extracted time series features of each word, the obtained phonetic information of each phone in each word, and the audio signal included in the audio file to a lexical stress model to obtain misplaced lexical stress in each of words in the English speech with different number of syllables without expanding short words to cause input approximation, input the obtained phonetic information of each phone in each word to a vowel model or a consonant model to obtain each mispronounced phone in each word of the English speech, and output each word with the pronunciation error at least corresponding to one or more of a vowel, a consonant, and a lexical stress in the text transcript.

In one embodiment, the processor is further configured to input the audio signal included in the audio file to an alignment acoustic model to obtain time boundaries of each word and each phone in each word, input the audio signal included in the audio file and the obtained time boundaries of each word and each phone in each word to a posterior probability acoustic model to obtain posterior probability distribution of each senone of each phone in each word, correlate the obtained time boundaries of each word and each phone in each word and the obtained posterior probability distribution of each senone of each phone in each word to obtain the posterior probability distribution of each phone in each word, and output the time boundaries of each word and each phone in each word, and the posterior probability distribution of each phone in each word.

In one embodiment, the processor is further configured to receive time boundaries of each word and each phone in each word, and posterior probability distribution of each phone in each word, determine an actual label (vowel or consonant) of each phone in each word based on lexicon, identify each phone having a corresponding posterior probability below a pre-configured threshold as a mispronounced phone, and output each mispronounced phone in the text transcript.

In one embodiment, the processor is further configured to receive the extracted time series features of each word, time boundaries of each word and each phone in each word, posterior probability distribution of each phone in each word, the audio signal included in the audio file, and the corresponding text transcript, input the time series features of each word, the time boundaries of each word and each phone in each word, the posterior probability distribution of each phone in each word, the audio signal included in the audio file, and the corresponding text transcript to the lexical stress model to obtain a lexical stress in each word, determine whether the lexical stress in each word is misplaced based on lexicon, and output each word with a misplaced lexical stress in the text transcript.

In one embodiment, the processor is further configured to combine each word with at least one mispronounced phone and each word with a misplaced lexical stress together as the word with the pronunciation error, and output each word with the pronunciation error in the text transcript.

Various embodiments may further provide a computer program product. The computer program product may include a non-transitory computer readable storage medium and program instructions stored therein, the program instructions being configured to be executable by a computer to cause the computer to perform operations including the disclosed methods.

In some embodiments, the English pronunciation assessment device may further include a user interface for the user to input the audio file and the corresponding text transcript and to view the pronunciation errors in the text transcript.

In the embodiments of the present disclosure, the English pronunciation assessment device includes the acoustic model trained with a combination of the speeches spoken by native speakers and speeches spoken by non-native speakers without labeling out mispronunciations, which substantially improves the mispronunciation detection precision from 0.58 to 0.74 at a recall rate of 0.5. Further, the accent-based features and the accent one hot encoding are incorporated into the acoustic model to further improve the detection precision. The acoustic model for detecting the misplaced lexical stresses takes time series features as input to fully explore input information. The network structure of the acoustic model intrinsically adapts to words with different numbers of syllables, without expanding short words, thereby reducing input approximation and improving the detection precision. Thus, the English pronunciation assessment device detects the mispronunciations and misplaced lexical stresses more accurately to provide a more desirable user experience.

Although the principles and implementations of the present disclosure are described by using specific embodiments in the specification, the foregoing descriptions of the embodiments are only intended to help understand the method and core idea of the method of the present disclosure. Meanwhile, a person of ordinary skill in the art may make modifications to the specific implementations and application range according to the idea of the present disclosure. In conclusion, the content of the specification should not be construed as a limitation to the present disclosure.

What is claimed is:

1. A computer-implemented English pronunciation assessment method, comprising:
receiving an audio file including an English speech and a text transcript corresponding to the English speech;
inputting audio signal included in the audio file to one or more acoustic models to obtain phonetic information of each phone in each word of the English speech, wherein the one or more acoustic models are trained with speeches spoken by native speakers and further with speeches spoken by non-native speakers without labeling out mispronunciations, such that a pronunciation error is detected more accurately based on the one or more acoustic models trained with speeches by both native and non-native speakers;
extracting time series features of each word contained in the inputted audio signal to convert each word of varying length into a fixed length feature vector;
inputting the extracted time series features of each word, the obtained phonetic information of each phone in each word, and the audio signal included in the audio file to a lexical stress model to obtain misplaced lexical stress in each of words in the English speech with different number of syllables without expanding short words to cause input approximation; and
outputting each word with the pronunciation error at least corresponding to a lexical stress in the text transcript.

2. The method according to claim 1, further including:
inputting the obtained phonetic information of each phone in each word to a vowel model or a consonant model to obtain each mispronounced phone in each word of the English speech; and
outputting each word with the pronunciation error at least corresponding to one or more of a vowel, a consonant, and the lexical stress in the text transcript.

3. The method according to claim 1, wherein:
the phonetic information includes at least time boundaries of each word and each phone in each word and posterior probability distribution of each senone of each phone in each word; and
the time series features include at least frequencies, energy, and Mel Frequency Cepstrum Coefficient (MFCC) features.

4. The method according to claim 1, wherein inputting the audio signal included in the audio file to the one or more acoustic models includes:
inputting the audio signal included in the audio file to an alignment acoustic model to obtain time boundaries of each word and each phone in each word;
inputting the audio signal included in the audio file and the obtained time boundaries of each word and each phone in each word to a posterior probability acoustic model to obtain posterior probability distribution of each senone of each phone in each word;
correlating the obtained time boundaries of each word and each phone in each word and the obtained posterior probability distribution of each senone of each phone in each word to obtain the posterior probability distribution of each phone in each word; and
outputting the time boundaries of each word and each phone in each word, and the posterior probability distribution of each phone in each word.

5. The method according to claim 2, wherein inputting the obtained phonetic information of each phone in each word to the vowel model or the consonant model includes:
receiving time boundaries of each word and each phone in each word, and posterior probability distribution of each phone in each word;
determining an actual label (vowel or consonant) of each phone in each word based on lexicon;
identifying each phone having a corresponding posterior probability below a pre-configured threshold as a mispronounced phone; and
outputting each mispronounced phone in the text transcript.

6. The method according to claim 1, wherein inputting the extracted time series features of each word, the obtained phonetic information of each phone in each word, and the audio signal included in the audio file to the lexical stress model to obtain the misplaced lexical stress in each of the words in the English speech with different number of syllables without expanding short words to cause the input approximation includes:
receiving the extracted time series features of each word, time boundaries of each word and each phone in each word, posterior probability distribution of each phone in each word, the audio signal included in the audio file, and the corresponding text transcript;
inputting the time series features of each word, the time boundaries of each word and each phone in each word, the posterior probability distribution of each phone in each word, the audio signal included in the audio file, and the corresponding text transcript to the lexical stress model to obtain a lexical stress in each word;
determining whether the lexical stress in each word is misplaced based on lexicon; and
outputting each word with a misplaced lexical stress in the text transcript.

7. The method according to claim 2, wherein outputting each word with the pronunciation error at least corresponding to one or more of the vowel, the consonant, and the lexical stress in the text transcript includes:
combining each word with at least one mispronounced phone and each word with a misplaced lexical stress together as the word with the pronunciation error; and
outputting each word with the pronunciation error in the text transcript.

8. The method according to claim 4, wherein:
the alignment acoustic model includes a Gaussian mixture model (GMM) cascaded with a hidden Markov model (HMM) or a neural network model (NNM) cascaded with the HMM.

9. The method according to claim 8, wherein:
the GMM is made up of a linear combination of Gaussian densities:
f(x)=Σₘ₌₁^{M} αₘϕ(x; μₘ, Σₘ)
where αₘ is the mixing proportions with Σαₘ=1, and each ϕ(x; μₘ, Σₘ) is a Gaussian density with mean μₘ and covariance matrix Σₘ.

10. The method according to claim 8, wherein:
the NNM is a factorized time delayed neural network (TDNNF).

11. The method according to claim 10, wherein:
the TDNNF includes five hidden layers;
each hidden layer of the TDNNF is a 3-stage convolution; and5
the 3-stage convolution includes a 2×1 convolution constrained to dimension 256, a 2×1 convolution constrained to dimension 256, and a 2×1 convolution back to the hidden layer constrained to dimension 1536.

12. The method according to claim 8, wherein:
the HMM is a state-clustered triphone model for modeling each phone with three distinct states; and
a phonetic decision tree is used to cluster similar states together.

13. The method according to claim 4, wherein:
the posterior probability acoustic model includes a neural network model (NNM) cascaded with a hidden Markov model (HMM);
an input to the posterior probability acoustic model includes the audio signal aligned with the time boundaries and the time series features extracted from the audio signal; and
an output from the posterior probability acoustic model includes the posterior probability distribution of each senone of each phone in each word.

14. The method according to claim 6, wherein the lexical stress model includes at least:
a second logic level including bidirectional long short-term memory (LSTM) models;
a third logic level including multiple blocks of LSTM models and high-way layers;
a fourth logic level including an inner attention layer;
a fifth logic level including multiple blocks of self-attention and position-wise feed-forward-network layers; and
a sixth logic level including target labels corresponding to all syllables of each word.

15. The method according to claim 14, wherein:
the maximum number of LSTM steps is limited to 50; and
each LSTM step corresponds to 10ms duration.

16. An English pronunciation assessment device, comprising:
a memory for storing program instructions; and
a processor for executing the program instructions stored in the memory to perform:
receiving an audio file including an English speech and a text transcript corresponding to the English speech;
inputting audio signal included in the audio file to one or more acoustic models to obtain phonetic information of each phone in each word of the English speech, wherein the one or more acoustic models are trained with speeches spoken by native speakers and further with speeches spoken by non-native speakers without labeling out mispronunciations, such that a pronunciation error is detected more accurately based on the one or more acoustic models trained with speeches by both native and non-native speakers;
extracting time series features of each word contained in the inputted audio signal to convert each word of varying length into a fixed length feature vector;
inputting the extracted time series features of each word, the obtained phonetic information of each phone in each word, and the audio signal included in the audio file to a lexical stress model to obtain misplaced lexical stress in each of words in the English speech with different number of syllables without expanding short words to cause input approximation; and
outputting each word with the pronunciation error at least corresponding to a lexical stress in the text transcript.

17. The device according to claim 16, further including a human-computer interface configured to:
allow a user to input the audio file including the English speech and the text transcript corresponding to the English speech; and
display to the user each word with the pronunciation error at least corresponding to the lexical stress in the text transcript.

18. The device according to claim 16, wherein the processor is further configured to perform:
inputting the obtained phonetic information of each phone in each word to a vowel model or a consonant model to obtain each mispronounced phone in each word of the English speech; and
outputting each word with the pronunciation error at least corresponding to one or more of a vowel, a consonant, and the lexical stress in the text transcript.

19. The device according to claim 16, wherein:
the phonetic information includes at least time boundaries of each word and each phone in each word and posterior probability distribution of each senone of each phone in each word; and
the time series features include at least frequencies, energy, and Mel Frequency Cepstrum Coefficient (MFCC) features.

19. A computer program product comprising a non-transitory computer readable storage medium and program instructions stored therein, the program instructions being configured to be executable by a computer to cause the computer to perform operations comprising:
receiving an audio file including an English speech and a text transcript corresponding to the English speech;
inputting audio signal included in the audio file to one or more acoustic models to obtain phonetic information of each phone in each word of the English speech, wherein the one or more acoustic models are trained with speeches spoken by native speakers and further with speeches spoken by non-native speakers without labeling out mispronunciations, such that a pronunciation error is detected more accurately based on the one or more acoustic models trained with speeches by both native and non-native speakers;
extracting time series features of each word contained in the inputted audio signal to convert each word of varying length into a fixed length feature vector;
inputting the extracted time series features of each word, the obtained phonetic information of each phone in each word, and the audio signal included in the audio file to a lexical stress model to obtain misplaced lexical stress in each of words in the English speech with different number of syllables without expanding short words to cause input approximation; and
outputting each word with the pronunciation error at least corresponding to a lexical stress in the text transcript.
